(19) United States
(12) Patent Application Publication
(10) Pub. No.: US 2010/0190637 A1
(43) Pub. Date: Jul. 29, 2010

(54) Curing Catalyst

(75) Inventors: Matthias Koch, Wiesbaden (DE); Sabine Renker, Limburg (DE); Gerhard Jonschker, Heppenheim (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck Patent Gesellschaft, Darmstadt (DE)

(21) Appl. No.: 12/665,516

(22) PCT Filed: May 23, 2008
(86) PCT No.: PCT/EP2008/004153

§ 371 Date: Dec. 18, 2009

(30) Foreign Application Priority Data
Jun. 22, 2007 (DE) 102007032189.0

(51) Int. Cl. B01J 23/06; C01G 9/02; B01J 21/06; B01J 31/22; B01J 31/18; B01J 31/02

(52) U.S. Cl. 502/158; 423/622; 502/253; 502/164; 502/150; 502/162; 502/168; 977/700; 977/773

(57) ABSTRACT

The invention relates to the use of nanoscale zinc oxide, prepared by a sol-gel process, as curing catalyst, in particular for liquid coatings.

The invention relates to the use of nanoscale zinc oxide, prepared by a sol-gel process, as curing catalyst, in particular for liquid coatings.

Liquid coatings essentially consist of binders (polymer resins), solvents, fillers and pigments as well as assistants, also known as additives. Varnishes do not comprise pigments. The binders are responsible for film formation and the film properties. The pigments give the coating its colour, while fillers are approximately “optically neutral” and influence various properties of the coating film (inter alia hardness, resistance, polishability). Assistants are intended to improve certain coating and coating-film properties and serve, inter alia, as dryers, antifoams, flow-control agents, light-protection agents.

Liquid coatings can be differentiated in accordance with various basic criteria. One possible differentiation can take place into one-component and two-component systems. In one-component systems, the coating comprises all constituents necessary for film formation. Two-component systems consist of a stock coating material and a curing agent, which is added just before processing. Two-component coatings can cure at room temperature and are usually more chemically and mechanically stable than one-component systems.

Liquid coatings, in particular two-component PU coatings (two-component polyurethane coatings), are cured principally using dibutyltin dilaurate (DBTL).

Soluble tin compounds, in particular organotin compounds, are a health risk. Replacement of these compounds is therefore desirable.

A further disadvantage of organometallic catalysts is migration thereof in the finished product, i.e. they may be released to the environment. A further disadvantage is the odour of the organometallic compound, which can cause problems in production, but also in the end product. In amine-crosslinking systems, a reduction in the amount of amine is desirable since the amines can have an adverse effect on the weathering stability of the coatings.

The object of the invention was therefore to provide a curing catalyst which is effective in various liquid coating systems, does not migrate and is odour-free.

This object is, surprisingly, achieved by the use according to the invention of nanoscale zinc oxide, prepared by a sol-gel process, as curing catalyst. Due to the catalytic effect of the zinc oxide nanoparticles, a shortening of the time necessary for curing the coating system is observed.

The effectiveness of zinc oxide nanoparticles depends, as also in the case of other catalysts, on the type of coating system. However, it is surprising here that the curing functions very well with surface-modified, preferably silanised, zinc oxide particles, although this type of surface coating of the particles would instead be expected to have a screening effect. Comparative examples in this respect are given in the examples part.

The invention therefore relates to the use of nanoscale zinc oxide, prepared by a sol-gel process, as curing catalyst.

For the purposes of the present invention, nanoscale in relation to the zinc oxide particles according to the invention means essentially spherical. These particles are particularly preferably up to 25 nm in size in the trans-parent application.

It is possible to add the curing catalyst in powder form, i.e. as isolated zinc oxide nanoparticles, to the coating material. The addition to the coating system preferably takes place in the form of a dispersion comprising nanoscale zinc oxide. A preferred embodiment of the invention is therefore the use of nanoscale zinc oxide, prepared by a sol-gel process, characterised in that the nanoscale zinc oxide in a dispersion is added to the system to be cured, i.e., in particular, the liquid coating system. The dispersion may on the one hand already be formed directly during production of the zinc oxide nanoparticles, or through redispersion of isolated zinc oxide nanoparticles. To this end, the particles can be precipitated by addition of a non-solvent (poor dispersion medium), filtered and washed and then dispersed in a good dispersion medium. Alternatively, the washed particles can be dried.

For the purposes of the present invention, the term “nanoscale zinc oxide” is also used synonymously for “zinc oxide nanoparticles”.

The nanoscale zinc oxide used in accordance with the invention consists of ZnO particles which have an average particle size, determined by means of particle correlation spectroscopy (PCS), of 1 to 500 nm. The particles according to the invention preferably have an average particle size, determined by means of particle correlation spectroscopy (PCS) or through a transmission electron microscope, of 2 to 100 nm, preferably 3 to 20 nm.

In a preferred embodiment, nanoscale zinc oxide is used in accordance with the invention, where the nanoscale zinc oxide has been surface-modified by means of at least one silane. Hydrophobicising and optionally additionally functional silanes are used here for the surface modification of the nanoscale zinc oxide. The choice of silanes is made in accordance with the properties of the coating. Suitable functionalisation is distinguished by the fact that it favours the incorporation and homogeneous distribution of the particles. Homogeneous distribution is important for an optimum catalytic effect.

In a particularly preferred embodiment, nanoscale zinc oxide is used in accordance with the invention, characterised in that it is prepared by a process in which in a step a) one or more precursors of the ZnO nanoparticles are converted into the nanoparticles in an alcohol, in a step b) the growth of the nanoparticles is terminated by addition of at least one silane when the particle size, determined through the position of the absorption edge in the UV/VIS spectrum, has reached the desired value, optionally in step c) the alcohol from step a) is removed, and optionally in step d) an organic solvent is added in order to give a dispersion of the ZnO nanoparticles in an organic solvent.

However, the addition of at least one silane is generally carried out here, as described above, 1 to 50 min after commencement of the reaction, preferably 10 to 40 min after commencement of the reaction and particularly preferably after about 30 min, depending on the desired particle size, determined via the position of the absorption edge. The position of the absorption edge in the UV spectrum is dependent on the particle size in the initial phase of zinc-oxide particle growth. At the beginning of the reaction, it is at about 300 nm and moves in the direction of 370 nm in the course of time. Addition of the silane enables the growth to be interrupted at any desired point.

The nanoparticles produced in this way are isolated in step c) by adding a poor dispersion medium for the functionalised particles, which is homogeneously miscible with the alcohol, to the reaction mixture. The particles precipitate out in the process and can be filtered off and then taken up in a good dispersion medium. Any salt load forming remains in the alcohol and can thus be separated off. The choice of precipitant is made in accordance with the silane used, by means of criteria which are known to the person skilled in the art.

For example, organofunctional silanes are employed.

Silane-based surface modifiers of this type are described, for example, in DE 40 11 044 C2. Suitable silanes are, for example, vinyltrimethoxysilane, aminopropyltriethoxysilane, N-ethylamino-N-propyldimethoxysilane, 3-isocyanatopropyltriethoxysilane, 3-mercaptopropyltrimethoxysilane, vinyltriethoxysilane, vinylethyldichlorosilane, vinylmethyldiacetoxysilane, vinylmethyldichlorosilane, vinylmethyldiethoxysilane, vinyltriacetoxysilane, vinyltrichlorosilane, phenylvinyldiethoxysilane, phenylallyldichlorosilane, 3-methacryloxypropyltrimethoxysilane, 3-glycidyloxypropyltrimethoxysilane, 1,2-epoxy-4-(ethyltriethoxysilyl)cyclohexane, 3-acryloxypropyltrimethoxysilane, 2-methacryloxyethyltrimethoxysilane, 2-acryloxyethyltrimethoxysilane, 3-methacryloxypropyltriethoxysilane, 3-acryloxypropyltrimethoxysilane, 2-methacryloxyethyltriethoxysilane, 2-acryloxyethyltriethoxysilane, 3-methacryloxypropyltris(methoxyethoxy)silane, 3-methacryloxypropyltris(butoxyethoxy)silane, 3-methacryloxypropyltris(propoxy)silane, 3-methacryloxypropyltris(butoxy)silane, 3-acryloxypropyltris(methoxyethoxy)silane, 3-acryloxypropyltris(butoxyethoxy)silane, 3-acryloxypropyltris(propoxy)silane, 3-acryloxypropyltris(butoxy)silane, hexadecyltrimethoxysilane or mixtures thereof. Particular preference is given to the use of 3-glycidyloxypropyltrimethoxysilane, hexadecyltrimethoxysilane or mixtures thereof. These and further silanes are commercially available, for example from ABCR GmbH & Co., Karlsruhe, or Sivento Chemie GmbH, Düsseldorf.

However, it is also possible to employ amphiphilic silanes as surface modifiers, as described in WO 2007/059841 on pages 10 to 24. A particularly preferred amphiphilic silane is 2-(2-hexyloxyethoxy)ethyl (3-trimethoxysilanylpropyl)carbamate.

The reaction temperature in the process described can be selected in the range between room temperature and the boiling point of the alcohol selected. The reaction rate can be controlled through a suitable choice of the reaction temperature, the starting materials and the concentration thereof and of the solvent, so that the person skilled in the art will have absolutely no difficulties in controlling the rate in such a way that monitoring of the course of the reaction by means of UV spectroscopy is possible.

In a further embodiment, it may be preferred to follow the surface modification by silanisation with a further surface modification by reaction with at least one further surface modifier selected from the group consisting of quaternary ammonium compounds, phosphonates, phosphonium and sulfonium compounds or mixtures thereof.

The requirements of a surface modifier are met, in particular, by an adhesion promoter which carries two or more functional groups. One group of the adhesion promoter reacts chemically with the oxide surface of the nanoparticle. Alkoxysilyl groups (for example methoxy-, ethoxysilanes), halosilanes (for example chlorosilanes) or acidic groups of phosphoric acid esters or phosphonic acids and phosphonic acid esters come into consideration here. The groups described are linked to a second functional group via a spacer of a certain length. This spacer is a nonreactive alkyl chain, siloxane, polyether, thioether or urethane or a combination of these groups of the general formula (C,Si)ₙHₘ(N,O,S)ₓ, where n=1-50, m=2-100 and x=0-50. The functional group is preferably an acrylate, methacrylate, vinyl, amino, cyano, isocyanate, epoxide, carboxyl or hydroxyl group.

Phosphoric acid-based surface modifiers are obtainable, inter alia, as Lubrizol® 2061 and 2063 from LUBRIZOL (Langer & Co.). Vinylphosphonic acid and diethyl vinylphosphonate may also be mentioned here as adhesion promoters (manufacturer: Hoechst AG, Frankfurt am Main).

In a further variant, the nanoscale zinc oxide used in accordance with the invention can also be prepared by the following process, where in a step a) one or more precursors of the ZnO nanoparticles are converted into the nanoparticles in an alcohol, in a step b) the growth of the nanoparticles is terminated by addition of at least one copolymer comprising at least one monomer containing hydrophobic radicals and at least one monomer containing hydrophilic radicals when the particle size, determined through the position of the absorption edge in the UV/VIS spectrum, has reached the desired value, optionally in step c) the alcohol from step a) is removed, and optionally in step d) an organic solvent is added in order to give a dispersion in an organic solvent.

Copolymers preferably to be employed exhibit a weight ratio of structural units containing hydrophobic radicals to structural units containing hydrophilic radicals in the random copolymers which is in the range 1:2 to 500:1, preferably in the range 1:1 to 100:1 and particularly preferably in the range 7:3 to 10:1. The weight-average molecular weight of the random copolymers is usually in the range from M_{w}=1000 to 1,000,000 g/mol, preferably in the range from 1500 to 100,000 g/mol and particularly preferably in the range 2000 to 40,000 g/mol.

The weight-average molecular weight of the random copolymers is determined by GPC (GPC=gel permeation chromatography) against PMMA standard (PMMA=polymethyl methacrylate).

It has been found here that, in particular, copolymers which conform to the formula I

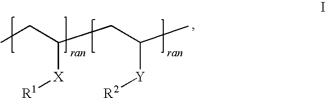

where X and Y correspond to the radicals of conventional nonionic or ionic monomers and
R¹ stands for hydrogen or a hydrophobic side group, preferably selected from branched or unbranched alkyl radicals having at least 4 carbon atoms, in which one or more, preferably all, H atoms may be replaced by fluorine atoms, and
R² stands for a hydrophilic side group, which preferably contains one or more phosphonate, phosphate, phosphonium, sulfonate, sulfonium, (quaternary) amine, polyol or polyether radicals, particularly preferably one or more hydroxyl radicals,
ran means that the respective groups are randomly distributed in the polymer, and where —X—R¹ and —Y—R² can each have a plurality of different meanings within a molecule and the copolymers, besides the structural units shown in formula I, may contain further structural units, preferably those without or with short side chains, such as, for example, C₁₋₄-alkyl, which meet the requirements in a particular manner.

Polymers of this type and the preparation thereof are described in International Patent Application WO 2005/070979, the disclosure content of which in this respect expressly also belongs to the contents of the present application.

In a variant of the invention, particular preference is given to polymers in which —Y—R² stands for a betaine structure.

Particular preference is in turn given here to polymers of the formula I in which X and Y stand, independently of one another, for —O—, —C(═O)—O—, —C(═O)—NH—, —(CH₂)ₙ—, phenylene or pyridyl. Furthermore, polymers in which at least one structural unit contains at least one quaternary nitrogen or phosphorus atom, where R² preferably stands for a side group —(CH₂)ₘ—(N⁺(CH₃)₂)—(CH₂)ₙ—SO₃⁻ or a side group —(CH₂)ₘ—(N⁺(CH₃)₂)—(CH₂)ₙ—PO₃²⁻, —(CH₂)ₘ—(N⁺(CH₃)₂)—(CH₂)ₙ—O—PO₃²⁻ or a side group —(CH₂)ₘ—(P⁺(CH₃)₂)—(CH₂)ₙ—SO₃⁻, where m stands for an integer from the range from 1 to 30, preferably from the range 1 to 6, particularly preferably 2, and n stands for an integer from the range from 1 to 30, preferably from the range 1 to 8, particularly preferably 3, can advantageously be employed.

It may be particularly preferred here for at least one structural unit of the copolymer to contain a phosphonium or sulfonium radical.

Random copolymers particularly preferably to be employed can be prepared in accordance with the following scheme:

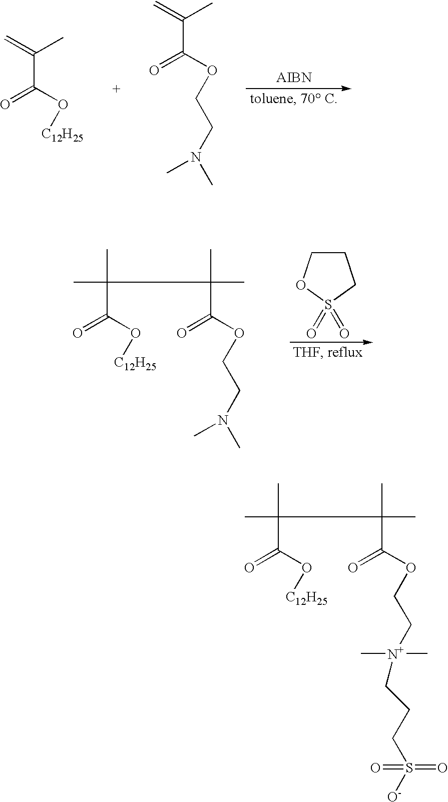

The desired amounts of lauryl methacrylate (LMA) and dimethylaminoethyl methacrylate (DMAEMA) are copolymerised here by known processes, preferably by means of free radicals in toluene by addition of AIBN. A betaine structure is subsequently obtained by reaction of the amine with 1,3-propane sultone by known methods.

In another variant of the invention, it is preferred to employ a copolymer essentially consisting of lauryl methacrylate (LMA) and hydroxyethyl methacrylate (HEMA), which can be prepared in a known manner by free-radical polymerisation in toluene using AIBN.

Alternative copolymers preferably to be employed may contain styrene, vinylpyrrolidone, vinylpyridine, halogenated styrene or methoxystyrene, where these examples do not represent a restriction. In another, likewise preferred embodiment, use is made of polymers which are characterised in that at least one structural unit is an oligomer or polymer, preferably a macromonomer, where polyethers, polyolefins and polyacrylates are particularly preferred as macromonomers.

Furthermore, further structural units, preferably those containing no hydrophilic or hydrophobic side chains or containing short side chains, such as C₁₋₄-alkyl, may be present in the copolymers besides the at least one structural unit containing hydrophobic radicals and the at least one structural unit containing hydrophilic radicals.

The position of the absorption edge in the UV spectrum is dependent on the particle size in the initial phase of zinc-oxide particle growth. At the beginning of the reaction, it is at about 300 nm and moves in the direction of 370 nm in the course of time. The growth can be interrupted at any desired point by addition of the random copolymer as modifier.

The reaction in step a) in the process described above is carried out in an alcohol. It has proven advantageous here for the alcohol to be selected in such a way that the copolymer to be employed in accordance with the invention is soluble in the alcohol itself. In particular, methanol or ethanol is suitable. Ethanol has proven to be a particularly suitable solvent for step a).

In the processes indicated, the copolymer is added, as described above, depending on the desired absorption edge, but generally 1 to 120 minutes after commencement of the reaction, preferably 5 to 60 minutes after commencement of the reaction and particularly preferably after 10 to 40 minutes.

In a further variant, the nanoscale zinc oxide used in accordance with the invention can also be prepared, dispersed in an organic solvent, by the following process, in which one or more precursors of the nanoparticles are reacted with a compound M₃₋ₓ[O₃₋ₓSiR₁₊ₓ] in an organic solvent to give the nanoparticles, where x stands for an integer selected from 0, 1 and 2, M stands for H, Li, Na or K, and all R each stand, independently of one another, for a branched or unbranched, saturated or unsaturated hydrocarbon radical having 1 to 28 C atoms, in which one or more C atoms may be replaced by O.

This preparation process allows economical production of the particles since higher solids contents can be achieved in the product suspension than on use of conventional hydroxide bases. In addition, the addition of the compound M₃₋ₓ[O₃₋ₓSiR₁₊ₓ] enables better stabilisation of the particles to be achieved over a broader size range, meaning that the time window for application of the modifying or compatibilising layers is significantly larger. Compatibilising in the present application means the functionalisation of the particles in such a way that transfer into organic, hydrophobic solvents, as is a prerequisite for many applications (for example in surface coatings), is possible. This can be achieved, for example, through suitable hydrophobic silanes.

A base MOH, where M stands for Li, Na or K, may additionally be employed in this preparation process, where the proportion of base in the total amount of M₃₋ₓ[O₃₋ₓSiR₁₊ₓ] and base can be up to 99.5%. If an additional base MOH is to be employed, the proportion of base is preferably 10-70 mol %, based on the total amount, or particularly preferably 30-60 mol %.

In compounds M₃₋ₓ[O₃₋ₓSiR₁₊ₓ], at least one radical R preferably stands for an alkoxy radical having 1 to 27 C atoms, preferably a methoxy or ethoxy radical.

In a further preferred embodiment, x stands for 2, and all R each stand, independently of one another, for methyl or ethyl.

In preferred compounds M₃₋ₓ[O₃₋ₓSiR₁₊ₓ], all R each stand, independently of one another, for methyl, ethyl, methoxy or ethoxy. It may furthermore be preferred for M to stand for K. It is particularly preferred for x to stand for 2 and for the formulae of the said compounds accordingly to be simplified to M[OSiR₃]. It is very particularly preferred here to use compounds of the formula K[OSiR₂CH₃], where R is as indicated above, where all R preferably stand for methyl.

It is furthermore possible to generate the compound M₃₋ₓ[O₃₋ₓSiR₁₊ₓ], where M stands for Li, Na or K, and x and R have a meaning indicated above, in situ from a base MOH and a compound R′₃₋ₓ[O₃₋ₓSiR₁₊ₓ], where R′ denotes an alkyl group having 1 to 16 C atoms, preferably having 1 to 4 C atoms, very particularly preferably ethyl.

Nanoparticle precursors which can be employed in all the processes described are zinc salts. Preference is given to the use of zinc salts of carboxylic acids or halides, in particular zinc formate, zinc acetate or zinc propionate, or zinc chloride. Zinc acetate or the dihydrate thereof is very particularly preferably used as precursor.

The conversion of the precursors into the zinc oxide in the processes described is preferably carried out in a basic medium, where a hydroxide base, such as LiOH, NaOH or KOH, is used in a preferred process variant.

In accordance with the invention, the nanoscale zinc oxide prepared by the processes outlined above can be used as curing catalyst for liquid coating systems. The nanoscale zinc oxide acts here as curing accelerator for condensation systems, i.e. in systems in which ester or amide bonds are formed and/or also in addition systems, for example in urethane formation. The curing catalysis particularly preferably takes place in two-component PU coatings.

A two-component PU system consists of a binder and a curing agent. Suitable binders are, in particular, polyacrylate-, polyester- or polyether-polyols. The curing agents used are preferably polyisocyanates based on HDI (hexamethylene diisocyanate), IPDI (isophorone diisocyanate) or TDI (2,4- and 2,6-tolylene diisocyanate).

Polyacrylate-polyols are particularly preferred here.

Compared with commercially available zinc oxide, the nanoscale ZnO, which can be prepared by the processes outlined above, can be incorporated homogeneously into the surface coatings and, in the usual use concentration of 0.01 to 0.1% by weight, but also significantly more, does not have an adverse effect on the transparency of the coatings. The surface modification of particles can take place in such a way that, on curing, binding into the coating takes place and migration, as can occur in the case of molecular compounds, such as DBTL and zinc salts, thus becomes impossible.

In accordance with the invention, the nanoscale zinc oxide prepared by the processes outlined above can be used as curing catalyst for silane-functional surface coatings, adhesives and/or sealants, in particular for silyl-terminated surface-coating binders, such as, for example, the polyorgano-silsesquioxanes which are known as “Ormocers” or “Nanomers” and have frequently been described, or copolymers, for example polyacrylates, which have been prepared, inter alia, using methacryloxypropyltrimethoxysilane or other silanes containing polymerisable double bonds as monomer.

In accordance with the invention, the nanoscale zinc oxide prepared by the processes outlined above can be used as curing catalyst in surface-coating formulations which, besides the classical surface-coating components, also comprise further nanoparticles.

The nanoparticles are particles essentially consisting of oxides or hydroxides of silicon, cerium, cobalt, chromium, nickel, zinc, titanium, iron, yttrium, zirconium or mixtures thereof, where the particles are preferably SiO₂ particles as supplementary component in the surface-coating formulation. The nanoparticles here ideally have a surface modification which ensures that they can be incorporated into the surface-coating system. Suitable surface-modified SiO₂ particles are known from the literature.

It is furthermore observed that the nanoscale zinc oxides described can generally be employed as replacement for organotin compounds, such as DBTL. DBTL is used in the preparation of polyurethanes and also in textile colouring and finishing. Besides the high toxicity of DBTL, a disadvantage is also the odour, which can cause problems in production, but also in the end product, and the ability to migrate in the finished product.

Further possible applications of the nanoscale zinc oxide, prepared by the processes described above, as replacement for DBTL are curing catalysis
in esterification processes in general, for example for the preparation of cosmetic oils, lubricants, plasticisers, surfactants or paint binders, such as polyesters, polyester-polyols, polylactides, polycaprolactones or alkyd resins;
in textile colouring and finishing using reactive dyes, brightening agents or functional resins for achieving textile properties, such as crease resistance or easy cleaning;
in epoxy resin curing of aliphatic or aromatic epoxides using amines, acids or other co-reactants which are employed in the use as adhesives and sealants or are used, in particular, for the preparation of glass- and carbon-fibre-reinforced plastics for motor vehicle and aircraft construction;
in moisture-curing or addition-crosslinking silicones;
in polyurethane systems, such as casting resins, elastomers, adhesives and sealants, dispersions or prepolymers.

The amount of nanoscale zinc oxide used as curing catalyst varies in the various surface-coating systems and should be determined experimentally.

Usual use concentrations are 0.01 to 0.1% by weight, based on the system as a whole.

The curing catalyst is preferably a constituent of the binder component and is used in the same way as additive, such as DBTL.

The following examples serve to illustrate the invention without restricting it. The invention can be carried out correspondingly throughout the range indicated in this description.

### EXAMPLES

### General

### Particle Correlation Spectroscopy

The measurements are carried out using a Malvern Zetasizer Nano ZS at room temperature. The measurement is carried out at a laser wavelength of 532 nm.

The sample volume in all cases is 1 ml with a concentration of 0.5 percent by weight of particles in butyl acetate. Before the measurement, the solutions are filtered using a 0.45 μm filter.

### Transmission Electron Microscopy

A Fei Company Tecnai 20F with field emission cathode is used. The photographs are taken at an acceleration voltage of 200 kV. Data acquisition on a Gatan 2k CCD camera.

### Preparation of the Liquid Samples Comprising Nanoparticles for Measurement in a Transmission Electron Microscope

For sample preparation, the solution comprising the nanoparticles is diluted to 1% by weight, and one drop of this solution is placed on a carbon-coated Cu grid, and the excess solution is immediately blotted off again using a filter paper. The sample is measured after drying at room temperature for one day.

### Preparation of Surface-Coating Samples Comprising Nanoparticles for Measurement in a Transmission Electron Microscope

The particle dispersion is mixed with the surface coating so that the ZnO content after drying of the coating layer is 5%. The coating is cured in a thick layer in a Teflon pan so that free-standing films having a thickness of at least 2 mm are formed. These samples are ultramicrotomed, without embedding, at room temperature using a 35° diamond knife, section thickness 60 nm. The sections are floated on water and transferred to carbon-coated Cu grids and measured.

### Example 1

### Preparation of the Random Copolymer

254 g of lauryl methacrylate (LMA), 130 g of hydroxyethyl methacrylate (HEMA), 1 g of azoisobutyronitrile (AIBN) and 10 ml of mercaptoethanol are dissolved in 350 ml of toluene. The mixture is degassed and warmed at 70° C. for 24 h with stirring. 200 mg of AIBN are then added, and the mixture is stirred at 70° C. for a further 18 h.

For work-up, all volatile constituents are removed in vacuo, giving a random copolymer of LMA and HEMA in the ratio 1:1 having a number-average molecular weight of around 2500 g/mol.

### Example 2a

### Production of Stabilised ZnO Particles

150 ml of an ethanolic KOH solution (0.123 mol/l) are added to 75 ml of an ethanolic Zn(AcO)₂*2H₂O solution (0.123 mol/l) at 50° C.

The conversion into zinc oxide and the growth of the nanoparticles can be monitored by UV spectroscopy. After a reaction duration of only one minute, the absorption maximum remains constant, i.e. the ZnO formation is already complete in the first minute. The absorption edge shifts to longer wavelengths with increasing reaction duration. This can be correlated with continuing growth of the ZnO particles due to Ostwald ripening.

When the absorption edge reaches the value of 360 nm, 20 ml of a solution of the random copolymer (weight concentration 100 g/l) from Example 1 are added. After the addition, no further shift in the absorption edge is observed. The suspension remains stable and transparent over a number of days.

A comparative experiment without addition of the polymer solution shows continued particle growth and becomes cloudy on continued observation.

For work-up, the ethanol is removed in vacuo, and the cloudy residue remaining is dissolved in butyl acetate. The potassium acetate formed during the reaction can be separated off as precipitate. The clear supernatant solution furthermore exhibits the characteristic absorption of zinc oxide in the UV spectrum.

UV spectroscopy and X-ray diffraction demonstrate the formation of ZnO. Furthermore, no potassium acetate reflections are visible in the X-ray pattern.

### Example 2b

### Production of Stabilised ZnO Particles

2.19 g of potassium hydroxide (Merck, 85% powder) are dissolved in 12.5 ml of methanol, and 4.13 g of ethoxytrimethylsilane are added. This solution is stirred at 50° C. for one hour.

4.43 g of zinc acetate dihydrate (Merck, 99.5%) are dissolved in 12.5 ml of methanol and heated to 50° C. When the target temperature has been reached, the pre-prepared silanolate solution is added. The conversion into zinc oxide and the growth of the nanoparticles can be monitored by UV spectroscopy. When the absorption edge reaches 360 nm (after 30 min), 275 μl of hexadecyltrimethoxysilane are added. The reaction mixture is stirred at 50° C. for 5 hours.

After cooling, the reaction mixture is transferred into a separating funnel, 25 ml of petroleum ether (boiling range 50-70° C.) are added, and the mixture is shaken. The phases are separated. The methanolic phase no longer exhibits any absorption. 10 ml of butyl acetate are added to the petroleum ether phase, and the petroleum ether is distilled off. The resultant solution exhibits the characteristic UV absorption edge at 360 nm.

### Example 3a

### Cloucryl, High-Gloss, Alfred Clouth Lackfabrik, for Use on Wood

In each case, 0.1 and 0.01% by weight of nanoscale ZnO from Examples 2a and 2b and commercial ZnO (Merck, zinc oxide, extra pure, Art. No.: 108846), calculated for the recipe as a whole, are added to the Cloucryl paint, and the paint is applied by air spraying in a layer thickness of 40 μm, dry. The paint films are dried at room temperature. This paint system is a solvent-containing two-component PU paint based on a polyacrylate-polyol which is cured using a polyisocyanate.

As a measure of the curing rate, the pot life is determined in accordance with DIN EN ISO 9514.

TABLE 1
Pot lives on use of various catalysts

| Catalyst [% by wt.] | Pot life [h] |
|---|---|
| none | 64 |
| 0.1% of ZnO (Ex. 2a) | 5 |
| 0.1% of ZnO (Ex. 2b) | 4.5 |
| 0.1% of commercial ZnO | 42 |
| 0.01% of ZnO (Ex. 2a) | 10 |
| 0.01% of ZnO (Ex. 2b) | 10 |
| 0.01% of commercial ZnO | 58 |

Of the catalysts investigated, the two zinc oxides prepared in accordance with the invention have the strongest catalytic action. In a comparative experiment with 0.1% of commercial ZnO, significant hazing of the paint layer is evident.

### Example 3b

### CAS-EMEA-BD-ICO Guide Recipe for Automotive Refinishing (Two-Component PU Paint, Principal Constituents: Polyacrylate and Aliphatic Polyisocyanate (Low-Viscosity HDI Trimer))

A concentration of 0.0174% by weight of curing catalyst is intended for the Bayer automotive refinish paint formulation used. The pot life for this concentration and for 0.01% by weight is determined. In these concentrations, nanoscale zinc oxide, prepared in accordance with Examples 2a or 2b, and also commercial ZnO (Merck, zinc oxide, extra pure, Art. No.: 108846) are employed.

The paint layers are applied by air spraying in a layer thickness of 40 μm, dry, and cured for 30 min at room temperature and subsequently for 30 min at 60° C.

TABLE 2
Pot lives on use of various catalysts

| Catalyst [% by wt.] | Pot life [h] |
|---|---|
| none | 11 |
| 0.0174% of ZnO (Ex. 2a) | 4 |
| 0.0174% of ZnO (Ex. 2b) | 4 |
| 0.0174% of commercial ZnO | 10.5 |
| 0.01% of ZnO (Ex. 2a) | 8.5 |
| 0.01% of ZnO (Ex. 2b) | 8 |
| 0.01% of commercial ZnO | 11 |

The zinc oxides prepared in accordance with Example 2a or 2b have a significantly better catalytic action than commercial zinc oxide.

### Example 3c

### Guide Recipe RR 4822 A, Bayer, for Use on Plastics (Two-Component PU Paint, Principal Constituents: Polyester/Polyacrylate and Aliphatic Polyisocyanate (HDI Trimer))

A concentration of 0.01% by weight of curing catalyst is intended for the Bayer RR 4822 plastic paint guide recipe used. The pot life for this concentration both for nanoscale zinc oxide, prepared in accordance with Example 2a or 2b, and also for commercial ZnO (Merck, zinc oxide, extra pure, Art. No.: 108846) is determined.

The paint layers are applied by air spraying in a thickness of 40 μm, dry, evaporated off for 10 min at room temperature and subsequently cured for 40 min at 100° C.

TABLE 3
Pot lives with various catalysts

| Catalyst [% by wt.] | Pot life [h] |
|---|---|
| none | 21 |
| 0.01% of ZnO (Ex. 2a) | 14.5 |
| 0.01% of ZnO (Ex. 2b) | 13.5 |
| 0.01% of commercial ZnO | 20 |

The zinc oxides prepared in accordance with Example 2a and 2b have a significantly better catalytic action than commercial zinc oxide.

### Comparative Example 4

For comparison with commercially available catalysts, 0.1 and 0.01% by weight of DBTL, and Borchi®-Kat 0244 from Borchers are employed in Cloucryl, high-gloss, Alfred Clouth Lackfabrik, and the pot life is determined:

Borchi®-Kat 0244 is a mixture of a bismuth salt of 2-ethylhexanoic acid and zinc salts of various branched fatty acids.

TABLE 4
Pot lives with various catalysts

| Catalyst [% by wt.] | Pot life [h] |
|---|---|
| none | 64 |
| 0.1% of ZnO (Ex. 2b) | 4.5 |
| 0.1% of DBTL | 9 |
| 0.1% of Borchi ®-Kat 0244 | 6 |
| 0.01% of ZnO (Ex. 2b) | 10 |
| 0.01% of DBTL | 19 |
| 0.01% of Borchi ®-Kat 0244 | 25 |

A significantly better action of the nanoscale zinc oxide compared with the commercially available products is evident. This is the case, in particular, at the low concentration of 0.01% by weight.

1. A method comprising using a nanoscale zinc oxide, prepared by a sol-gel process, as curing catalyst.

2. A method according to claim 1, characterised in that the nanoscale zinc oxide in a dispersion is added to the system to be cured.

3. A method according to claim 1, characterised in that the nanoscale zinc oxide has been surface-modified by means of a silane.

4. A method according to claim 1, characterised in that the nanoscale zinc oxide is prepared by a process in which in a step a) one or more precursors of the ZnO nanoparticles are converted into the nanoparticles in an alcohol, in a step b) the growth of the nanoparticles is terminated by addition of at least one silane when the particle size, determined through the position of the absorption edge in the UV/VIS spectrum, has reached the desired value, optionally in step c) the alcohol from step a) is removed, and optionally in step d) an organic solvent is added in order to give a dispersion in an organic solvent.

5. A method according to claim 1, characterised in that the surface modification is carried out by means of at least one organofunctional silane selected from the group vinyltrimethoxysilane, aminopropyltriethoxysilane, N-ethylamino-N-propyldimethoxysilane, 3-isocyanatopropyltriethoxysilane, 3-mercaptopropyltrimethoxysilane, vinyltriethoxysilane, vinylethyldichlorosilane, vinylmethyldiacetoxysilane, vinylmethyldichlorosilane, vinylmethyldiethoxysilane, vinyltriacetoxysilane, vinyltrichlorosilane, phenylvinyldiethoxysilane, phenylallyldichlorosilane, 3-methacryloxypropyltrimethoxysilane, 3-glycidyloxypropyltrimethoxysilane, 1,2-epoxy-4-(ethyltriethoxysilyl)cyclohexane, 3-acryloxypropyltrimethoxysilane, 2-methacryloxyethyltrimethoxysilane, 2-acryloxyethyltrimethoxysilane, 3-methacryloxypropyltriethoxysilane, 3-acryloxypropyltrimethoxysilane, 2-methacryloxyethyltriethoxysilane, 2-acryloxyethyltriethoxysilane, 3-methacryloxypropyltris(methoxyethoxy)silane, 3-methacryloxypropyltris(butoxyethoxy)silane, 3-methacryloxypropyltris(propoxy)silane, 3-methacryloxypropyltris(butoxy)silane, 3-acryloxypropyltris(methoxyethoxy)silane, 3-acryloxypropyltris(butoxyethoxy)silane, 3-acryloxypropyltris(propoxy)silane, 3-acryloxypropyltris(butoxy)silane, hexadecyltrimethoxysilane or mixtures thereof.

6. A method according to claim 1, characterised in that, besides the silanisation, the nanoscale zinc oxide has a further surface modification, obtained by reaction with at least one further surface modifier selected from the group consisting of quaternary ammonium compounds, phosphonates, phosphonium and sulfonium compounds or mixtures thereof.

7. A method according to claim 1, characterised in that the nanoscale zinc oxide is prepared by a process in which in a step a) one or more precursors of the ZnO nanoparticles are converted into the nanoparticles in an alcohol, in a step b) the growth of the nanoparticles is terminated by addition of at least one copolymer comprising at least one monomer containing hydrophobic radicals and at least one monomer containing hydrophilic radicals when the particle size, determined through the position of the absorption edge in the UV/VIS spectrum, has reached the desired value, and optionally in step c) the alcohol from step a) is removed, and optionally in step d) an organic solvent is added in order to give a dispersion in an organic solvent.

8. A method according to claim 1, characterised in that the nanoscale zinc oxide, dispersed in an organic solvent, is obtainable by a process in which one or more precursors of the nanoparticles are reacted with a compound M₃₋ₓ[O₃₋ₓSiR₁₊ₓ] in an organic solvent to give the nanoparticles, where x stands for an integer selected from 0, 1 and 2, M stands for H, Li, Na or K, and all R each stand, independently of one another, for a branched or unbranched, saturated or unsaturated hydrocarbon radical having 1 to 28 C atoms, in which one or more C atoms may be replaced by O.

9. A method according to claim 1, characterised in that the nanoscale zinc oxide is prepared from precursors selected from the group of the zinc salts of carboxylic acids or halides.

10. A method according to claim 1, characterised in that the curing catalysis takes place in liquid coatings.

11. A method according to claim 10, characterised in that the catalysis takes place during the curing of condensation or addition systems in liquid coatings.

12. A method according to claim 10, characterised in that the curing catalysis takes place in two-component PU coatings.

13. A method according to claim 10, characterised in that the curing catalysis takes place in silane-functional surface coatings, adhesives and/or sealants.

14. A method according to claim 10, characterised in that the curing catalysis takes place in surface-coating formulations which, besides the nanoscale zinc oxide as curing catalyst, comprise further nanoparticles.

15. A method according to claim 14, characterised in that the nanoparticles are SiO₂ particles.
